(19) United States
(12) Patent Application Publication
(10) Pub. No.: US 2015/0109619 A1
(43) Pub. Date: Apr. 23, 2015

(54) SAMPLE ANALYSIS ELEMENT AND DETECTION DEVICE

(71) Applicant: SEIKO EPSON CORPORATION, Tokyo (JP)

(72) Inventors: Mamoru Sugimoto, Chino (JP); Jun Amako, Shiki (JP); Hideaki Nishida, Chino (JP)

(73) Assignee: SEIKO EPSON CORPORATION, Tokyo (JP)

(21) Appl. No.: 14/396,608

(22) PCT Filed: Apr. 12, 2013
(86) PCT No.: PCT/JP2013/002504

§ 371 Date: Oct. 23, 2014

(30) Foreign Application Priority Data
Apr. 26, 2012 (JP) 2012-101021

(51) Int. Cl. G01N 21/03; G01N 21/552

(52) U.S. Cl. CPC G01N 21/03; G01N 21/554
USPC 356/445; 356/244

(57) ABSTRACT

There is provided a sample analysis element capable of achieving enhancement of the near-field light while increasing the surface density of the hot spots.

The sample analysis element is provided with a base body. Nanostructures are dispersed on a surface of the base body at a first pitch SP smaller than a wavelength of incident light. In each of the nanostructures, a dielectric body is covered with a metal film. The nanostructures form a plurality of nanostructure groups. The nanostructure groups are arranged in one direction at a second pitch LP larger than the first pitch SP.

### BACKGROUND

1. Technical Field

The present invention relates to a sample analysis element provided with nanobodies covered with a metal film, and a detection device or the like using such a sample analysis element.

2. Background Art

There is known a sample analysis element using localized surface plasmon resonance (LSPR). Such a sample analysis element is provided with nanobodies covered with, for example, a metal film. The nanobodies are each formed to be sufficiently smaller than the wavelength of excitation light, for example. When the metal film on the nanobodies is irradiated with the excitation light, all electric dipoles are aligned, and thus an enhanced electric field is induced. As a result, near-field light is generated on the surface of the metal film. So-called hot spots are formed.

In Lupin Du et al., “Localized surface plasmons, surface plasmon polaritons, and their coupling in 2D metallic array for SERS,” OPTICS EXPRESS, U.S., issued on Jan. 19, 2010, Vol. 18, No. 3, pp. 1959-1965, the nanobodies are arranged at a predetermined pitch forming a grid pattern. When the dimension of the pitch is set to a dimension corresponding to the wavelength of the propagating surface plasmon resonance (PSPR), enhancement of the near-field light is observed on the metal film on the nanobodies.

### SUMMARY

The sample analysis element described above can be used for a detection device of a target substance. As disclosed in Lupin Du et al., if the pitch is set at the dimension corresponding to the wavelength of the propagating surface plasmon resonance, the surface density of the hot spots is remarkably lowered, and it is hard for the target substance to adhere to the hot spots.

According to at least one of the aspects of the invention, it is possible to provide the sample analysis element capable of realizing the enhancement of the near-field light while increasing the surface density of the hot spots.

(1) An aspect of the invention relates to a sample analysis element including a base body, and a plurality of nanostructure groups each including nanostructures dispersed on a surface of the base body at a first pitch smaller than a wavelength of incident light, wherein in the nanostructure, a metal film covers a dielectric body, and the nanostructure groups are arranged in one direction at a second pitch larger than the first pitch.

On the metal film of the nanostructures, the localized surface plasmon resonance (LSPR) is induced due to the function of the incident light. According to observation by the inventors, it was confirmed that when the segmentation of the nanostructure groups was established, the near-field light was enhanced on the metal film of the nanostructure compared to the case in which the nanostructures were arranged throughout the entire surface at an equal pitch. Formation of so-called hot spots was confirmed. Moreover, since the plurality of nanostructures is disposed in each of the nanostructure groups, the surface density of the nanostructures is increased compared to the case in which the nanostructures, as simple bodies, are arranged at a pitch corresponding to the wavelength of the propagating surface plasmon resonance. Therefore, the surface density of the hot spots is increased.

(2) The second pitch can have a dimension based on a wavelength of a propagating surface plasmon resonance. According to the observation by the inventors, it was confirmed that if the second pitch was defined with such a dimension, the near-field light was enhanced on the metal film of the nanostructures. Formation of so-called hot spots was confirmed.

(3) A region where the nanostructure does not exist can be formed between the nanostructure groups. In other words, the nanostructure does not exist between the nanostructure groups. The localized surface plasmon resonance is not induced in a region between the nanostructure groups.

(4) The dielectric bodies of the nanostructures can be formed integrally with the base body using the same material. The dielectric bodies of the nanostructures and the base body can be formed of the same material. The dielectric bodies of the nanostructure groups and the base body can be formed using integral molding. The manufacturing process of the sample analysis element can be simplified. The mass productivity of the sample analysis element can be enhanced.

(5) The base body can be formed of a molding material. The dielectric bodies of the nanostructure groups and the base body can be formed using integral molding. The mass productivity of the sample analysis element can be enhanced.

(6) The metal film can cover the surface of the base body.

The metal film is only required to be formed uniformly on the surface of the base body. Therefore, the manufacturing process of the sample analysis element can be simplified. The mass productivity of the sample analysis element can be enhanced.

(7) The nanostructure groups can each be segmentalized into nanostructure groups arranged at the second pitch in a second direction intersecting with the one direction. In such a sample analysis element, the pitch can be set in the two directions intersecting with each other. As a result, the incident light can be provided with a plurality of polarization planes. The incident light can be provided with circularly-polarized light.

(8) A region where the nanostructure does not exist can be formed between the nanostructure groups obtained by the segmentalization. In other words, the nanostructure does not exist between the nanostructure groups. The localized surface plasmon resonance is not induced in a region between the nanostructure groups.

(9) The sample analysis element can be used while being incorporated in a detection device. The detection device can include the sample analysis element, a light source adapted to emit light toward the nanostructure groups, and a light detector adapted to detect light emitted from the nanostructure groups in accordance with irradiation with the light.

### BRIEF DESCRIPTION OF THE DRAWINGS

FIG. 1 is a perspective view schematically showing a sample analysis element according to an embodiment of the invention.

FIG. 2 is a vertical cross-sectional view along the 2-2 line shown in FIG. 1.

FIGS. 3A and 3B are a plan view and a side view, respectively, showing a unit of simulation models.

FIGS. 4A through 4E are plan views of a first model, a second model, a third model, a fourth model, and a fifth model, respectively, of the simulation models, and FIG. 4F is a plan view of a comparative model.

FIG. 5 is a graph showing a dispersion relationship created based on the electric field intensity.

FIG. 6 is a graph showing the maximum value of the electric field intensity.

FIG. 7 is a graph showing a square sum of the electric field intensity per unit area.

FIGS. 8A and 8B are a plan view and a side view, respectively, showing a first comparative unit.

FIG. 9 is a graph showing a wavelength dependency of the electric field intensity.

FIG. 10 is a cross-sectional view schematically showing projections formed on a surface of a silicon substrate.

FIG. 11 is a cross-sectional view schematically showing a nickel film formed on the surface of the silicon substrate.

FIG. 12 is a cross-sectional view schematically showing a nickel plate formed on the surface of the silicon substrate.

FIG. 13 is a cross-sectional view schematically showing the nickel plate peeled off from the silicon substrate.

FIG. 14 is a cross-sectional view schematically showing a molding material molded with the nickel plate.

FIG. 15 is a cross-sectional view schematically showing a metal film deposited on a surface of a substrate.

FIG. 16 is a conceptual diagram schematically showing a configuration of a target molecule detection device.

FIG. 17 is a perspective view schematically showing a sample analysis element according to a modified example.

### DESCRIPTION OF EXEMPLARY EMBODIMENT

Hereinafter, an embodiment of the invention will be explained with reference to the accompanying drawings. It should be noted that the present embodiment explained below does not unreasonably limit the content of the invention as set forth in the appended claims, and all of the constituents explained in the present embodiment are not necessarily essential as means for solving the problem according to the invention.

### (1) Structure of Sample Analysis Element

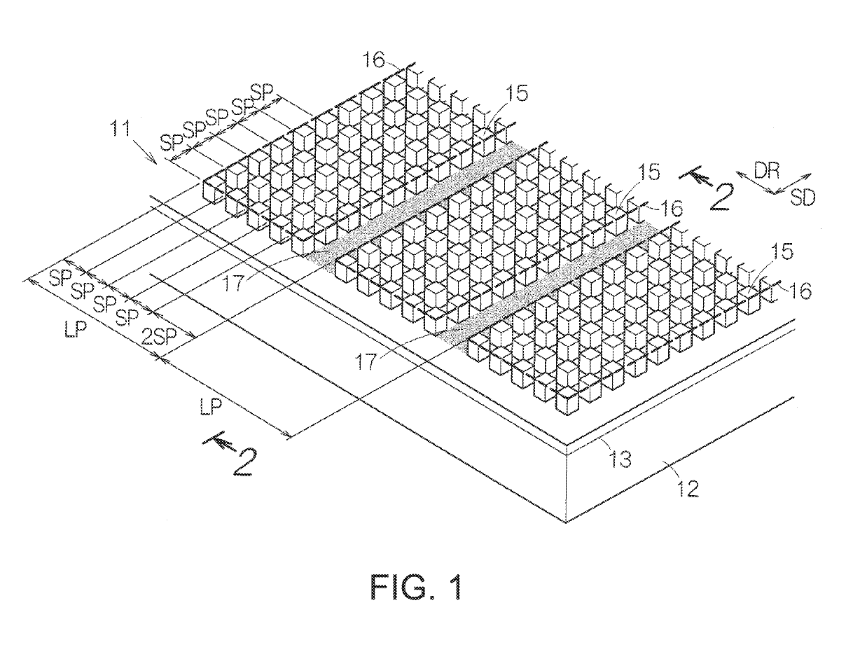

FIG. 1 schematically shows a sample analysis element 11 according to an embodiment of the invention. This sample analysis element 11, namely a sensor chip, is provided with a substrate (a base body) 12. The substrate 12 is formed of, for example, a molding material. As the molding material, a resin material can be used for example. Acrylic resin such as polymethylmethacrylate resin (PMMA resin) can be included in the resin material.

On the surface of the substrate 12, there is formed a metal film 13. The metal film 13 is formed of metal. The metal film 13 can be formed of, for example, silver. In addition, gold or aluminum can also be used as the metal. The metal film is formed on, for example, the entire surface of the substrate 12 continuously. The metal film 13 can be formed with an even film thickness. The film thickness of the metal film 13 can be set to, for example, about 20 nm.

On the surface of the metal film 13, there are formed nanostructures 15. The nanostructures 15 project from the surface of the metal film 13. The nanostructures 15 are dispersed on the surface of the substrate 12. Each of the nanostructures 15 is formed to be a prism. The horizontal cross-sectional surface, namely the contour, of the prism is formed to be, for example, a square. The length of a side of the square can be set to, for example, about 1 through 1000 nm. The height (from the surface of the metal film 13) of the prism can be set to, for example, about 10 through 100 nm. The horizontal cross-sectional surface of the prism can be formed to be a polygon other than a square. The nanostructures 15 can also be formed to be a three-dimensional shape such as a cylinder.

The nanostructures 15 form nanostructure groups 16. The nanostructure groups 16 are arranged in a first direction (one direction) DR at a predetermined long pitch LP (a second pitch). The dimension of the long pitch LP is set in such a manner as described later. Between the nanostructure groups 16, there is formed a planar region (a region where the nanostructure does not exist) 17 where the nanostructure does not exist. In other words, the nanostructure 15 does not exist in the region between the nanostructure groups 16 adjacent to each other.

In each of the nanostructure groups 16, the nanostructures 15 are arranged in the first direction DR at a short pitch SP (a first pitch). At the same time, in each of the nanostructure groups 16, the nanostructures 15 are arranged in a second direction (a second direction) SD intersecting with the first direction DR at the short pitch SP. Here, the second direction SD is perpendicular to the first direction DR in an imaginary plane including the surface of the substrate 12. Therefore, the plurality of nanostructures 15 is arranged in each of the nanostructure groups 16 forming a grid pattern at the short pitch SP. The short pitch SP is set to be smaller than at least the long pitch LP. In the nanostructure group 16, the distance between the nanostructures 15 adjacent to each other is set to be smaller than the distance, namely the width of the planar region 17 specified in the first direction DR, between the nanostructure groups 16 adjacent to each other. Here, the width of the planar region 17 is set to be larger than the short pitch SP. In other words, the distance between the nanostructure groups 16 is set to be larger than the short pitch SP.

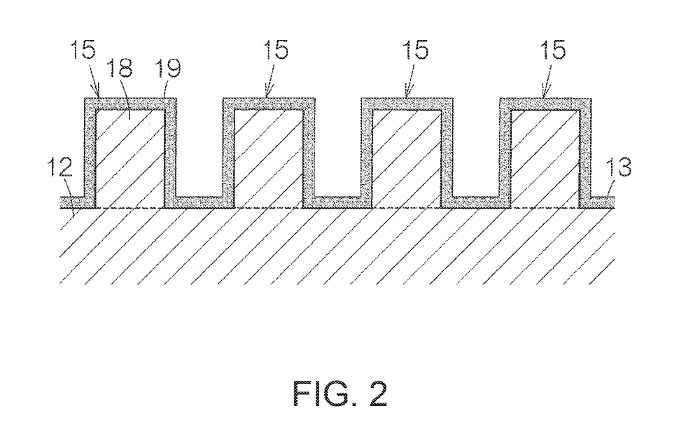

As shown in FIG. 2, each of the nanostructures 15 is provided with a main body 18 made of a dielectric material. The main body 18 projects from the surface of the substrate 12. The main body 18 can be formed of the same material as the material of the substrate 12. The main body 18 can be formed integrally on the surface of the substrate 12 using the same material.

In each of the nanostructures 15, the surface of the main body 18 is covered with a metal film 19. The metal films 19 can be formed of the same material as that of the metal film 13. The metal films 19 and the metal film 13 can be formed as a single film. The metal film 19 can be formed with an even film thickness.

### (2) Verification of Electric Field Intensity

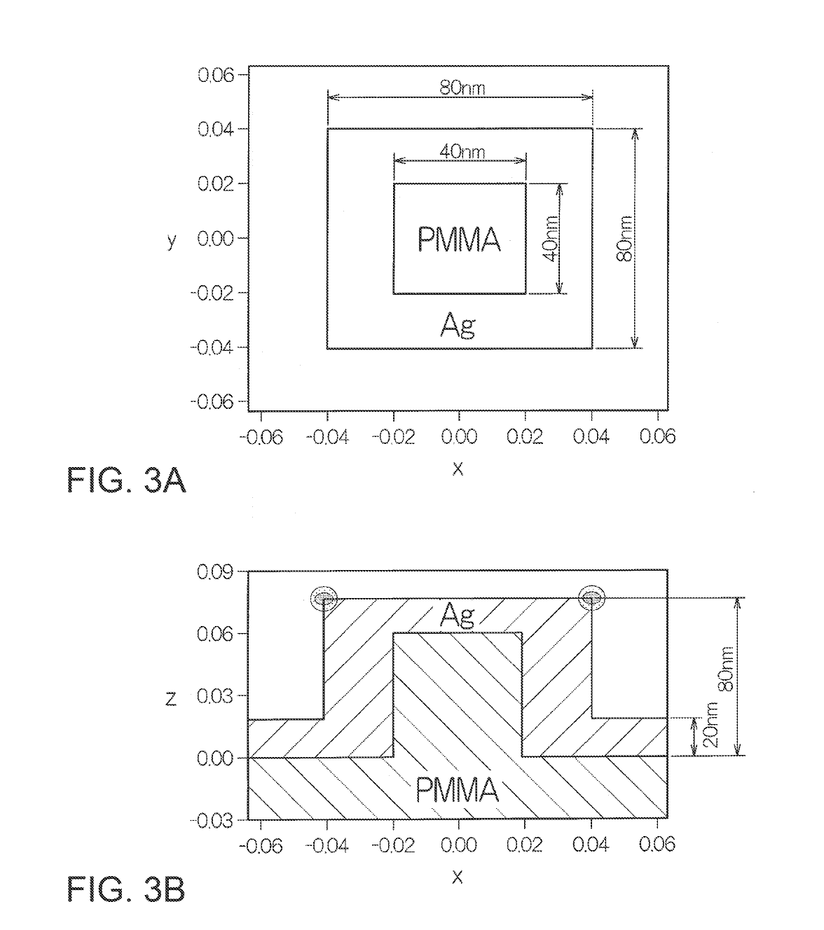

The inventors verified the electric field intensity of the sample analysis element 11. On the occasion of the verification, simulation software of FDTD (Finite-Difference Time-Domain) method was used. As shown in FIGS. 3A and 3B, the inventors built a unit of a simulation model based on Yee Cell. In the unit, there was formed the metal film 13 made of silver on the substrate 12 made of PMMA, 120 nm on a side. The film thickness of the metal film 13 was set to 20 nm. The contour of the main body 18 made of PMMA was set to a square, 40 nm on a side. The height (from the surface of the substrate 12) of the main body 18 was set to 60 nm.

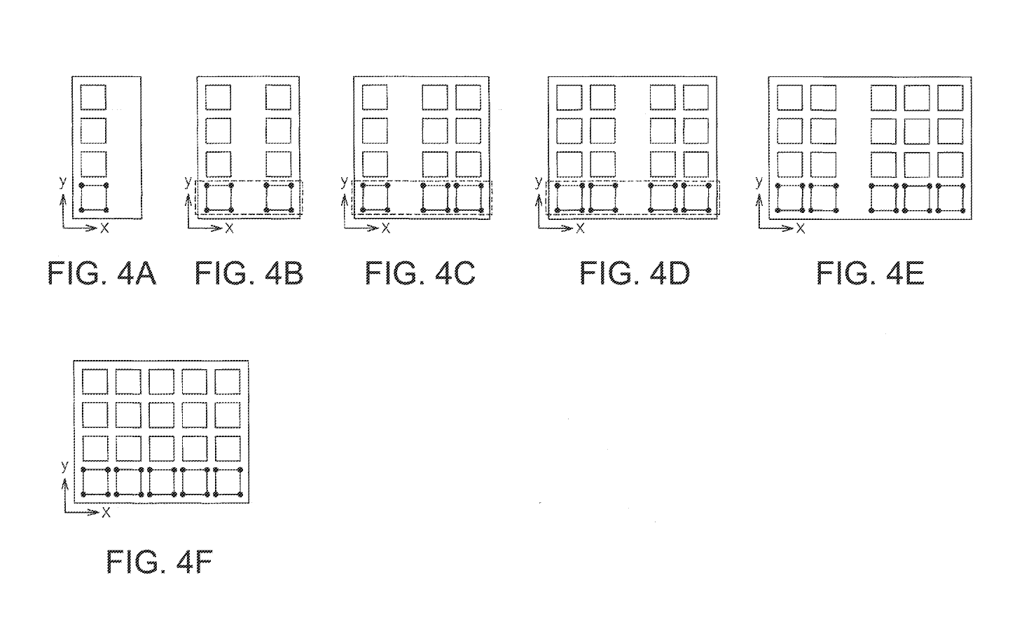

As shown in FIG. 4A, the long pitch LP of the nanostructure groups 16 in an x-axis direction was set to 240 nm in the first model. A line of units, namely the nanostructures 15, constituted the nanostructure group 16. As a result, between the nanostructure groups 16, there was formed the planar region 17 with a line of void units. The void unit was formed of a void, 120 nm on a side. The electric field intensity Ex was calculated in the leading one of the nanostructures 15. “Peripheral refractive index ns=1” was set. Incident light as linearly polarized light was set. The polarization plane was adjusted to the x-axis direction. The incident light was set to normal incidence. In the nanostructure 15, the electric field was concentrated at upper four vertexes.

As shown in FIGS. 4B through 4E, the long pitch LP of the nanostructure groups 16 in the x-axis direction was set to 360 nm, 480 nm, 600 nm, and 720 nm in the second through fifth models, respectively. In the models, the nanostructure group 16 was constituted by two lines, three lines, four lines, and five lines of units, namely the nanostructures 15, respectively. As a result, in each of the models, the planar region 17 was formed between the nanostructure groups 16 with a line of void units. The void unit was formed of a void, 120 nm on a side. Similarly to the first model, the electric field intensity Ex was calculated in the leading one of the nanostructures 15 in each of the models.

As shown in FIG. 4F, the inventors prepared a comparative model. In the comparative model, the planar region 17 was eliminated. In other words, the nanostructure group 16 was not set. Simply, the nanostructures 15 were arranged in a grid pattern at the short pitch SP. Similarly to the above, the electric field intensity Ex was calculated in selected one of the nanostructures 15.

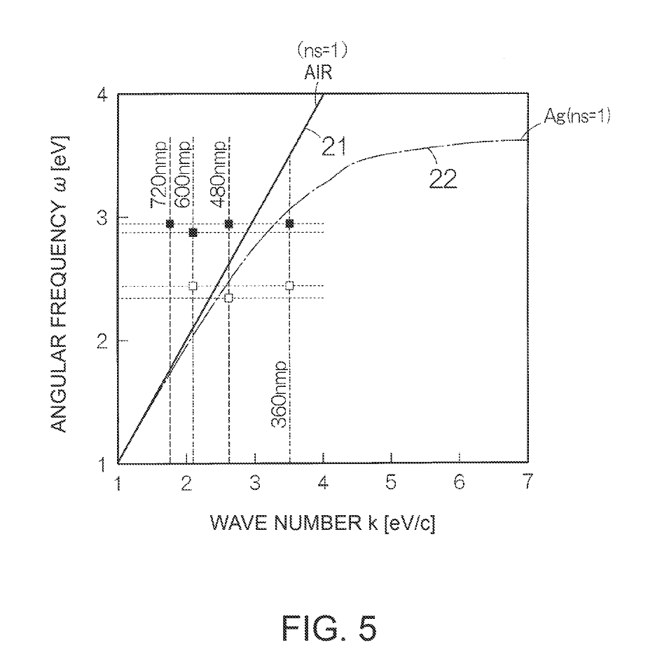

FIG. 5 shows a dispersion relationship created based on the electric field intensity Ex. Here, the square sum of the electrical field intensity Ex converted into values per unit area was identified. On the occasion of the identification of the square sum, the electric field intensity Ex was calculated at each of the upper four vertexes of the nanostructures 15. The square sum of the electric field intensity Ex was calculated for each of the vertexes, and then the square values of all of the vertexes in the minimum unit of the repeated calculation were added to each other. As the unit area, the area of the comparative model was set. The result of the addition was converted into a value per unit area thus set. In such a manner, the square sum of the electric field intensity Ex per unit area was calculated. The relationship between the wavelength of the incident light and the square sum, namely the frequency characteristic was calculated. The frequencies representing a first-order peak (a local maximum value) and a second-order peak were identified.

In FIG. 5, the wave number k is identified in accordance with the long pitch LP. The line 21 represents the dispersion relationship of air (ns=1.0). The dispersion relationship of air shows a proportional relationship. The curve 22 represents the dispersion relationship of the propagating surface plasmon resonance of silver Ag with the refractive index (ns=1.0). The black plot represents the angular frequency ω of the incident light forming the first-order peak (extremum) of the electric field intensity in the nanostructure 15 for each of the long pitches LP. While the angular frequency ω=2.88 [eV/c] was obtained in the fourth model (LP=600 nmp) and the comparative model (not shown), the angular frequency ω=2.95 [eV/c] was obtained in the second, third, and fifth models (LP=360 nmp, 480 nmp, and 720 nmp). The white plot represents the angular frequency ω of the incident light forming the second-order peak of the electric field intensity in the nanostructure 15 for each of the long pitches LP. While the angular frequency ω=2.43 [eV/c] was obtained in the second and fourth models (LP=360 nmp, 600 nmp), the angular frequency ω=2.34 [eV/c] was obtained in the third model (LP=480 nmp). So-called Anti-Crossing Behavior (known as an index of a hybrid mode) was not observed.

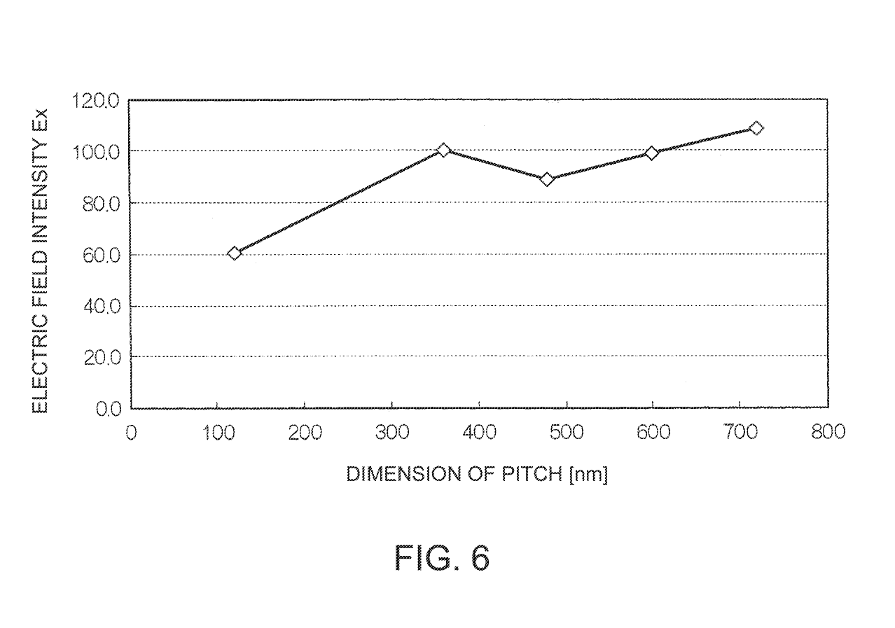

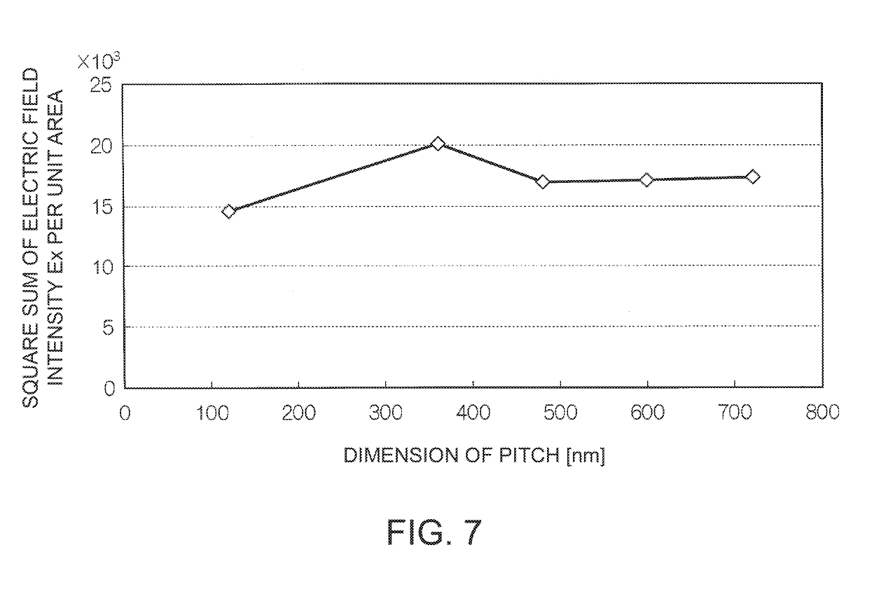

FIG. 6 shows the maximum values of the electric field intensity Ex. It was confirmed that the maximum value of the electric field intensity Ex increased in the second through fifth models compared to the comparative model. FIG. 7 shows the square sum of the electric field intensity Ex per unit area. It was confirmed that the square sum of the electric field intensity Ex per unit area increased in the second through fifth models compared to the comparative model. It was confirmed that in particular in the second model (LP=360 nmp), large values were obtained as both of the maximum value of the electric field intensity Ex and the square sum of the electric field intensity Ex per unit area.

On the metal films 19 of the nanostructures 15, the localized surface plasmon resonance (LSPR) is induced due to the function of the incident light. As is obvious from the verification result, it was confirmed that when the segmentation of the nanostructure groups 16 was established, the near-field light was enhanced on the metal films 19 of the nanostructures 15 compared to the case in which the nanostructures 15 were arranged through out the entire surface at an equal pitch. Formation of so-called hot spots was confirmed. Moreover, since the plurality of nanostructures 15 is disposed in each of the nanostructure groups 16, the surface density of the nanostructures 15 is increased compared to the case in which the nanostructures 15, as simple bodies, are arranged at a pitch corresponding to the wavelength of the propagating surface plasmon resonance. Therefore, the surface density of the hot spots is increased. It was confirmed that the near-field light was enhanced on the metal films 19 of the nanostructures 15 in particular in the case in which the long pitch LP was defined by a dimension corresponding to the wavelength of the propagating surface plasmon resonance.

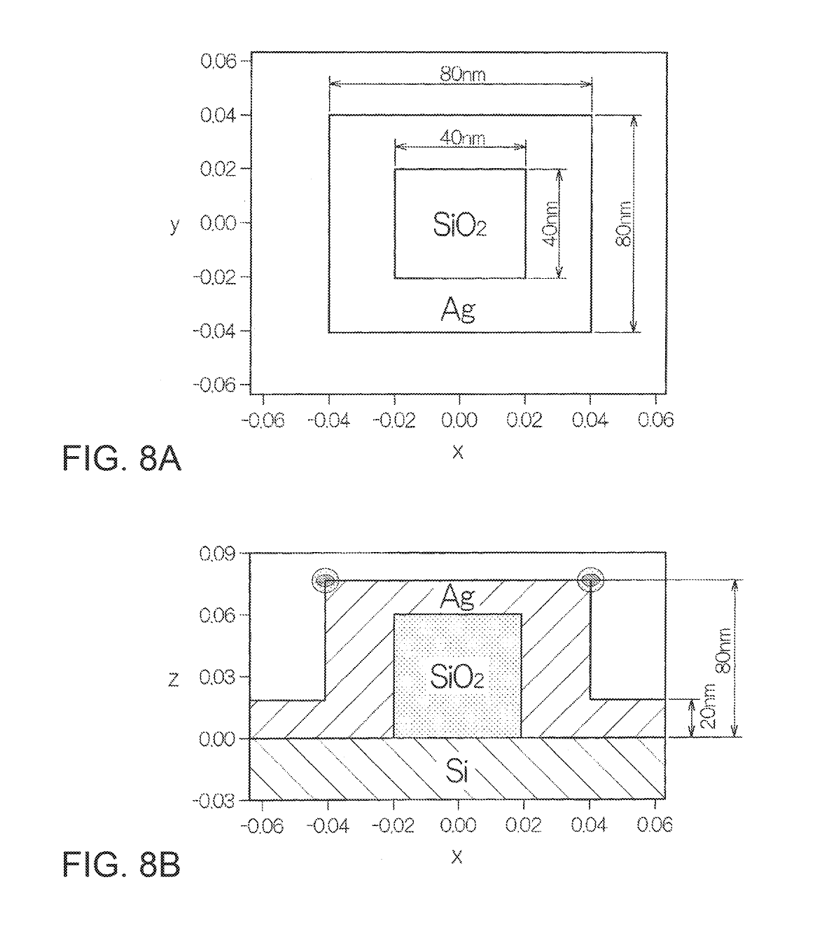

As shown in FIGS. 8A and 8B, the inventors prepared a first comparative unit. In the first comparative unit, there was formed the metal film 13 made of silver on the surface of the substrate 12 made of silicon (Si), 120 nm on a side. The film thickness of the metal film 13 was set to 20 nm. The main body 18 of the nanostructure 15 was formed of silicon dioxide (SiO₂). The other parts of the structure were formed similarly to the unit described above.

The inventors similarly prepared a second comparative unit. In the second comparative unit, there was formed the metal film 13 made of silver on the surface of the substrate 12 made of silicon dioxide (SiO₂), 120 nm on a side. The film thickness of the metal film 13 was set to 20 nm. The main body 18 of the nanostructure 15 was formed of silicon dioxide (SiO₂). In other words, the main body 18 of the nanostructure 15 and the substrate 12 were set to have an integral structure using the same material. The other parts of the structure were formed similarly to the unit described above.

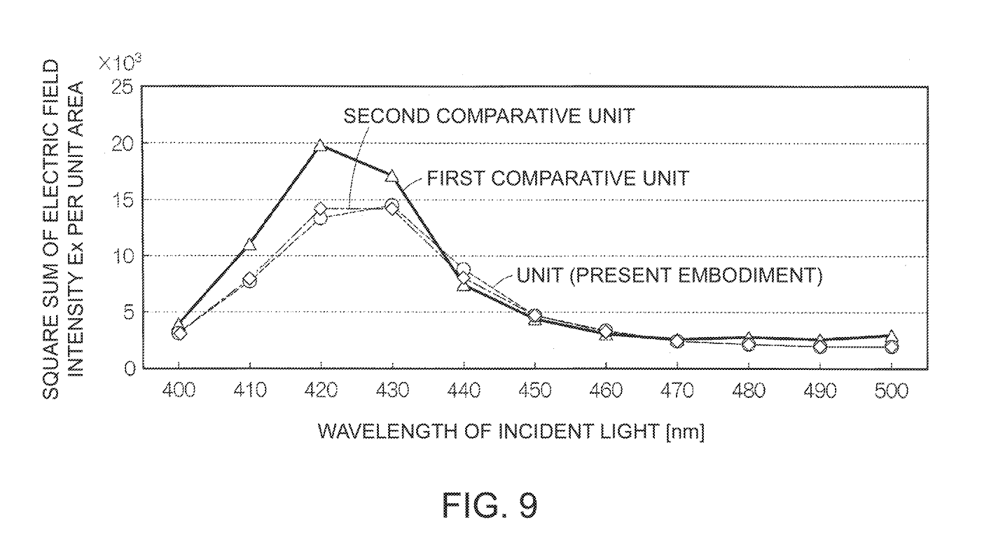

FIG. 9 shows the wavelength dependency of the electric field intensity Ex. On the occasion of the identification of the wavelength dependency, the comparative model was built with the unit, the first comparative unit, and the second comparative units. The square sum of the electric field intensity Ex per unit area was calculated similarly to the above for each of the wavelengths of the incident light in the comparative model. On this occasion, the refractive index of silicon dioxide was set to 1.45, and the refractive index of PMMA was set to 1.48. As is obvious from FIG. 9, in the first comparative unit, enhancement of the electric field intensity Ex was observed compared to the unit and the second comparative unit. Hardly any difference in electric field intensity Ex was observed between the unit and the second comparative unit. According to this result, in the first comparative unit, it is possible to easily presume that the electric field intensity Ex has increased due to the effect of the return light reflected by the surface of the substrate 12 made of silicon. On the other hand, if the main body 18 of the nanostructure 15 and the substrate 12 are formed integrally with the same material, the main body 18 of the nanostructure 15 and the substrate 12 can be formed of the same material. The main body 18 of the nanostructure 15 and the substrate 12 can be formed using integral molding. The manufacturing process of the sample analysis element 11 can be simplified. The mass productivity of the sample analysis element 11 can be enhanced. On the occasion of performing the integral molding, it is sufficient for the nanostructures 15 and the substrate 12 to be formed of the molding material.

As described above, the metal film 13 and the metal films 19 can be formed as a single film. Therefore, the metal films 13, 19 are only required to uniformly be formed on the surface of the substrate 12. As a result, the manufacturing process of the sample analysis element 11 can be simplified. The mass productivity of the sample analysis element 11 can be enhanced.

### (3) Manufacturing Method of Sample Analysis Element

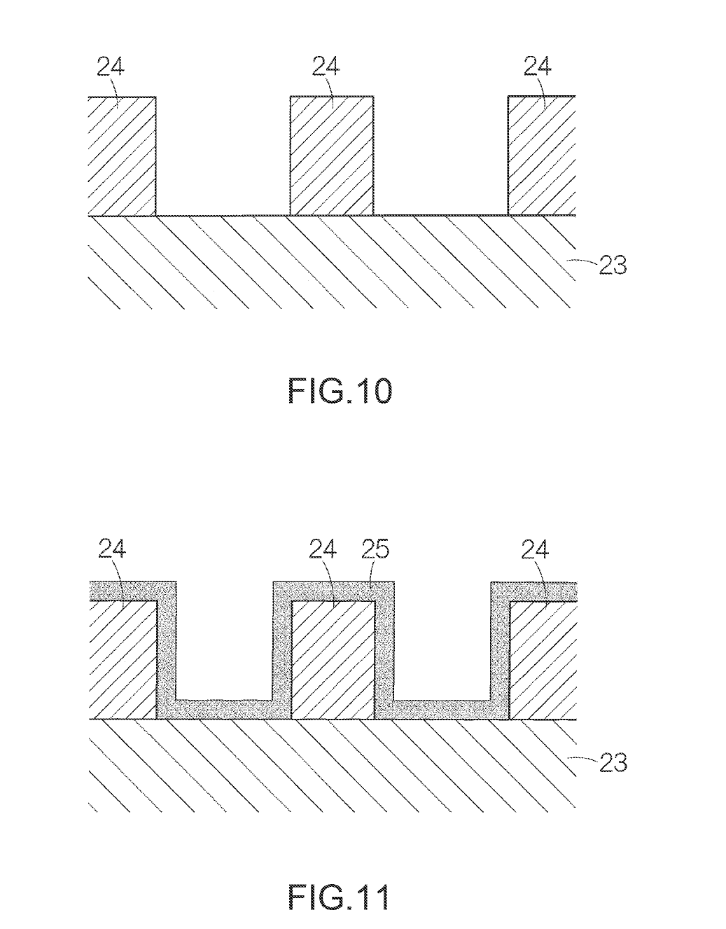

Then, a method of manufacturing the sample analysis element 11 will briefly be explained. On the occasion of the manufacture of the sample analysis element 11, a stamper is manufactured. As shown in FIG. 10, projections 24 of silicon dioxide (SiO₂) are formed on the surface of the silicon (Si) substrate 23. The surface of the silicon substrate 23 is formed to be a smooth surface. The projections 24 are modeled on the main bodies 18 of the nanostructures 15 dispersed on the surface of the substrate 12. On the occasion of forming the projections 24, a lithography technology, for example, can be used. A silicon dioxide film is formed entirely on the surface of the silicon substrate 23. A mask modeled on the main bodies 18 of the nanostructures 15 is formed on the surface of the silicon dioxide film. It is sufficient to use, for example, a photoresist film for the mask. When the silicon dioxide film is removed in the periphery of the mask, the individual projections 24 are formed from the silicon dioxide film. On the occasion of such formation, it is sufficient to perform an etching process or a milling process.

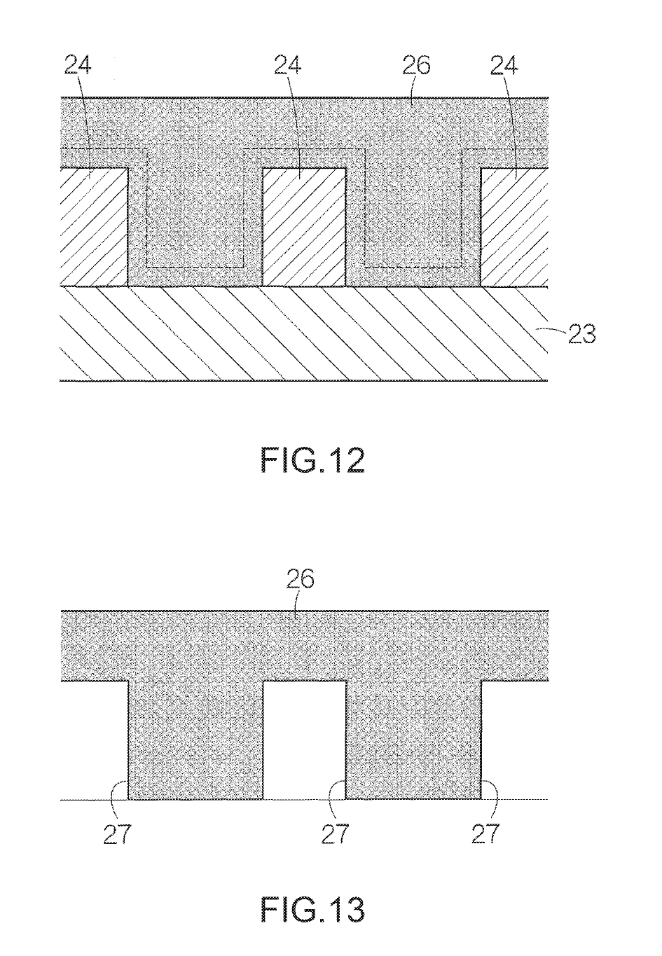

As shown in FIG. 11, a nickel (Ni) film 25 is formed on the surface of the silicon substrate 23. On the occasion of the formation of the nickel film 25, electroless plating is performed. Subsequently, as shown in FIG. 12, electrocasting is performed based on the nickel film 25. A nickel plate 26 large in thickness is formed on the surface of the silicon substrate 23. Subsequently, as shown in FIG. 13, the nickel plate 26 is peeled off from the silicon substrate 23. In such a manner, the stamper made of nickel can be manufactured. The surface of the nickel plate 26, namely the stamper, is formed to be a smooth surface. The smooth surface is provided with recesses 27 due to the peeling trace of the projections 24.

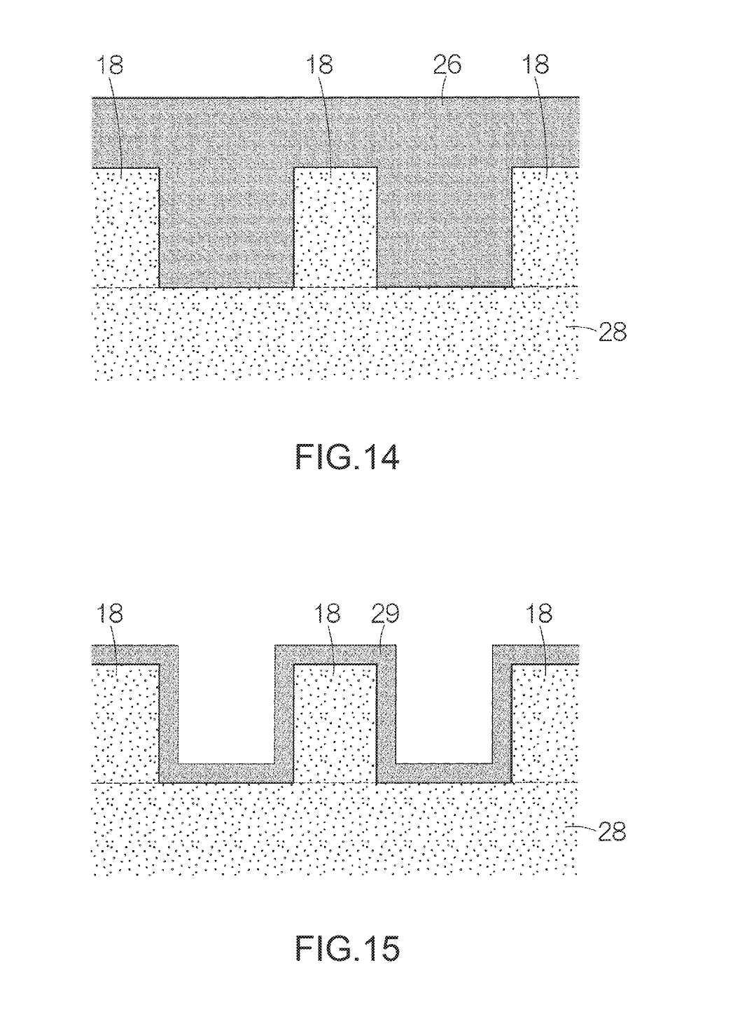

As shown in FIG. 14, a substrate 28 is molded. On the occasion of the molding, injection molding of, for example, the molding material can be used. On the surface of the substrate 28, the main bodies 18 of the nanostructures 15 are integrally molded. As shown in FIG. 15, a metal film 29 is formed entirely on the surface of the substrate 28. On the occasion of the formation of the metal film 29, electroless plating, sputtering, vapor deposition, and so on can be used. Subsequently, the individual substrates 12 are carved out from the substrate 28. The surface of the substrate 12 is covered with the metal film 13. The stamper makes a substantial contribution to the improvement of the productivity of the sample analysis element 11.

### (4) Detection Device According to Embodiment

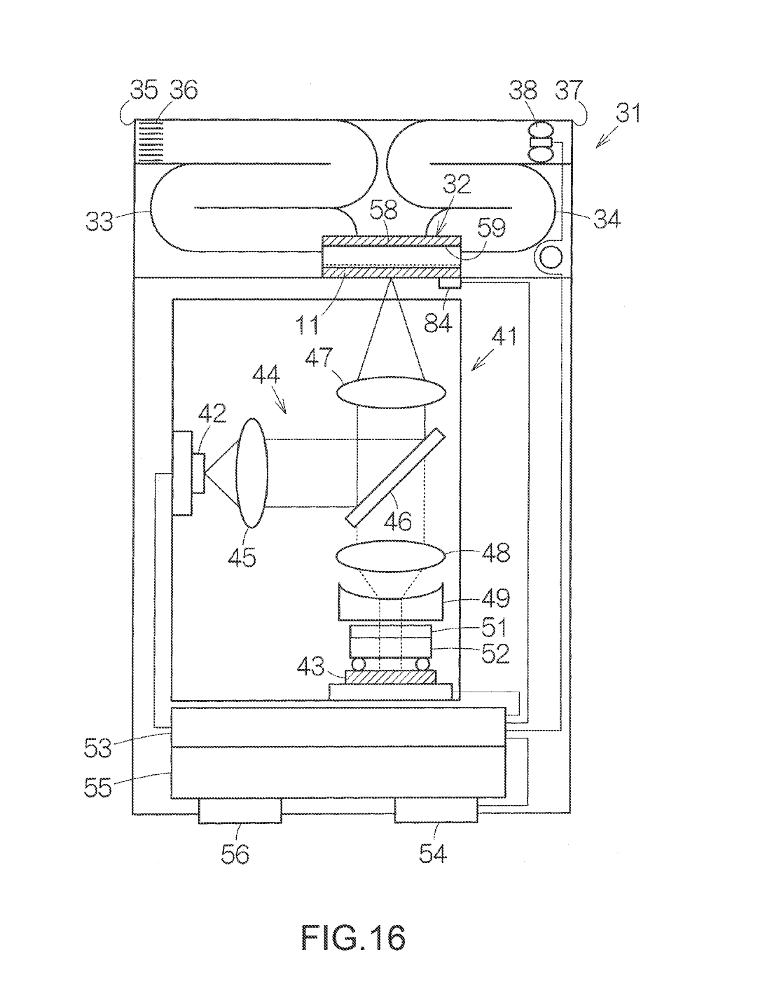

FIG. 16 schematically shows a target molecule detection device (detection device) 31 according to an embodiment. The target molecule detection device 31 is provided with a sensor unit 32. To the sensor unit 32, an introductory passage 33 and a discharge passage 34 are individually connected. A gas is introduced from the introductory passage 33 to the sensor unit 32. The gas is discharged from the sensor unit 32 to the discharge passage 34. A filter 36 is disposed in a passage entrance 35 of the introductory passage 33. The filter 36 can remove, for example, dust and moisture in the gas. A suction unit 38 is disposed in a passage exit 37 of the discharge passage 34. The suction unit 38 is formed of a blast fan. In accordance with the operation of the blast fan, the gas flows through the introductory passage 33, the sensor unit 32, and the discharge passage 34 in sequence. In such a flow channel of the gas, shutters (not shown) are disposed at anterior and posterior positions of the sensor unit 32. In accordance with the open-close operation of the shutters, the gas can be confined in the sensor unit 32.

The target molecule detection device 31 is provided with a Raman scattering light detection unit 41. The Raman scattering light detection unit 41 irradiates the sensor unit 32 with irradiation light to detect the Raman scattering light. The Raman scattering light detection unit 41 incorporates a light source 42. A laser source can be used for the light source 42. The laser source can radiate a laser beam, which is linearly polarized light, and has a specific wavelength (a single wavelength).

The Raman scattering light detection unit 41 is provided with a light receiving element (a light detector) 43. The light receiving element 43 can detect, for example, the intensity of the light. The light receiving element 43 can output a detection current in accordance with the intensity of the light. Therefore, the intensity of the light can be identified in accordance with the magnitude of the current output from the light receiving element 43.

An optical system 44 is built between the light source 42 and the sensor unit 32, and between the sensor unit 32 and the light receiving element 43. The optical system 44 forms an optical path between the light source 42 and the sensor unit 32, and at the same time, forms an optical path between the sensor unit 32 and the light receiving element 43. The light of the light source 42 is guided to the sensor unit 32 due to the function of the optical system 44. The reflected light of the sensor unit 32 is guided to the light receiving element 43 due to the function of the optical system 44.

The optical system. 44 is provided with a collimator lens 45, a dichroic mirror 46, a field lens 47, a collecting lens 48, a concave lens 49, an optical filter 51, and a spectroscope 52. The dichroic mirror 46 is disposed, for example, between the sensor unit 32 and the light receiving element 43. The field lens 47 is disposed between the dichroic mirror 46 and the sensor unit 32. The field lens 47 collects the parallel light supplied from the dichroic mirror 46, and then guides it to the sensor unit 32. The reflected light of the sensor unit 32 is converted by the field lens 47 into parallel light, and is then transmitted through the dichroic mirror 46. Between the dichroic mirror 46 and the light receiving element 43, there are disposed the collecting lens 48, the concave lens 49, the optical filter 51, and the spectroscope 52. The optical axes of the field lens 47, the collecting lens 48, and concave lens 49 are concentrically adjusted. The light collected by the collecting lens 48 is converted again into parallel light by the concave lens 49. The optical filter 51 removes the Rayleigh scattering light. The Raman scattering light passes through the optical filter 51. The spectroscope selectively transmits, for example, the light with a specific wavelength. In such a manner as described above, in the light receiving element 43, the intensity of the light is detected at each of the specific wavelengths. An etalon, for example, can be used for the spectroscope 52.

The optical axis of the light source 42 is perpendicular to the optical axes of the field lens 47 and the collecting lens 48. The surface of the dichroic mirror 46 intersects with these optical axes at an angle of 45 degrees. Between the dichroic mirror 46 and the light source 42, there is disposed the collimator lens 45. In such a manner as described above, the collimator lens 45 is made to face the light source 42. The optical axis of the collimator lens 45 is adjusted to be coaxial with the optical axis of the light source 42.

The target molecule detection device 31 is provided with a control unit 53. To the control unit 53, there are connected the light source 42, the spectroscope 52, the light receiving element 43, the suction unit 38, and other equipment. The control unit 53 controls the operations of the light source 42, the spectroscope 52, and the suction unit 38, and at the same time, processes the output signal of the light receiving element 43. To the control unit 53, there is connected a signal connector 54. The control unit 53 can exchange signals with the outside through the signal connector 54.

The target molecule detection device 31 is provided with a power supply unit 55. The power supply unit 55 is connected to the control unit 53. The power supply unit 55 supplies the control unit 53 with operating power. The control unit 53 can operate receiving the power supplied from the power supply unit 55. For example, a primary battery and a secondary battery can be used for the power supply unit 55. The secondary battery can include, for example, a power supply connector 56 for recharging.

The control unit 53 is provided with a signal processing control section. The signal processing control section can be formed of, for example, a central processing unit (CPU), and a storage circuit such as RAM (a random access memory) or ROM (a read-only memory). In the ROM, there can be stored, for example, a processing program and spectrum data. The spectrum of the Raman scattering light of the target molecule is identified with the spectrum data. The CPU executes the processing program while temporarily taking the processing program and the spectrum data in the RAM. The CPU compares the spectrum of the light identified by the function of the spectroscope and the light receiving element and the spectrum data with each other.

The sensor unit 32 is provided with the sample analysis element 11. The sample analysis element 11 is made to face a substrate 58. Between the sample analysis element 11 and the substrate 58, there is formed a gas chamber 59. The gas chamber 59 is connected to the introductory passage 33 at one end, and is connected to the discharge passage 34 at the other end. The nanostructure groups 16 are disposed inside the gas chamber 59. The light emitted from the light source 42 is converted by the collimator lens 45 into the parallel light. The light as the linear polarized light is reflected by the dichroic mirror 46. The light thus reflected is collected by the field lens 47, and the sensor unit 32 is irradiated with the light thus collected. On this occasion, the light can be input in a vertical direction perpendicular to the surface of the sample analysis element 11. So-called normal incidence can be established. The polarization plane of the light is adjusted to be parallel to the first direction DR of the sample analysis element 11. Due to the function of the light thus applied, the near-field light is enhanced by the nanostructures 15. So-called hot spots are formed.

On this occasion, if the target molecules adhere to the nanostructures 15 at the hot spots, the Rayleigh scattering light and the Raman scattering light are generated from the target molecules. So-called surface-enhanced Raman scattering is realized. As a result, the light is emitted toward the field lens 47 with the spectrum corresponding to the type of the target molecule.

In such a manner as described above, the light emitted from the sensor unit 32 is converted by the field lens 47 into the parallel light, and then passes through the dichroic mirror 46, the collecting lens 48, the concave lens 49, and the optical filter 51. The Raman scattering light enters the spectroscope 52. The spectroscope 52 disperses the Raman scattering light. In such a manner as described above, the light receiving element 43 detects the intensity of the light at each of the specific wavelengths. The spectrum of the light is compared with the spectrum data. The target molecule can be detected in accordance with the spectrum of the light. In such a manner as described above, the target molecule detection device 31 can detect the target substance such as adenovirus, rhinovirus, HIV virus, or flu virus based on the surface-enhanced Raman scattering.

### (5) Modified Example of Sample Analysis Element

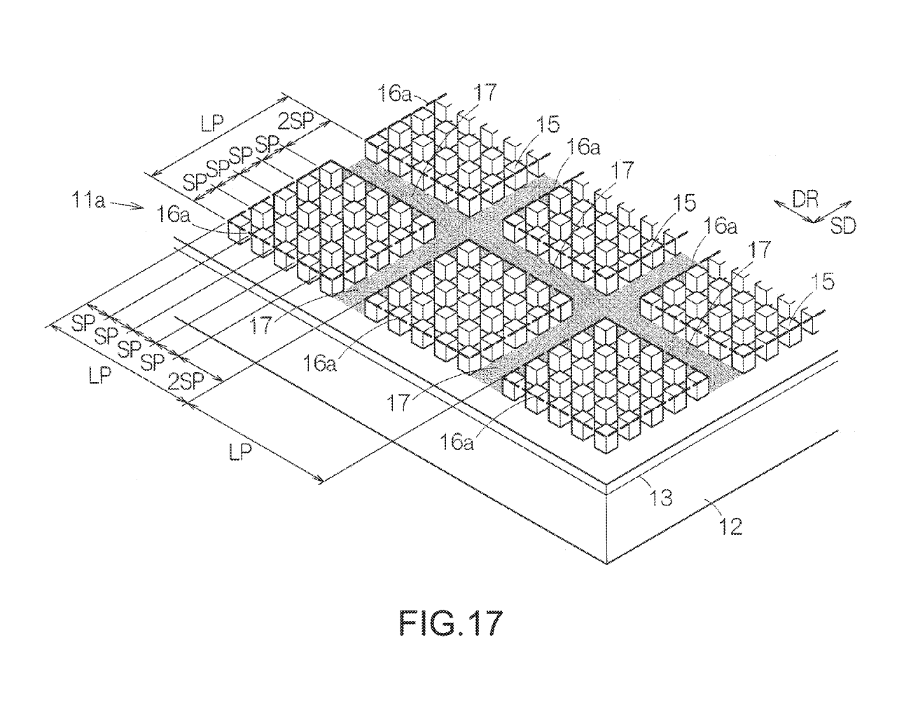

FIG. 17 schematically shows a sample analysis element 11a according to a modified example. In this sample analysis element 11a, the nanostructure groups 16a are segmentalized in a second direction SD in addition to the first direction DR described above. In other words, the nanostructure groups 16a are arranged in the first direction DR at a predetermined long pitch LP, and at the same time, arranged in the second direction SD at the predetermined pitch LP. In such a manner as described above, the planar region (the region where the metal nanostructure does not exist) 17 where the nanostructure does not exist is formed between the nanostructure groups 16a in the second direction SD in addition to the first direction DR. Besides the above, the configuration of the sample analysis element 11a according to the modified example is substantially the same as that of the sample analysis element 11 described above. In the drawing, the constituents and the structures equivalent to those of the sample analysis element 11 described above are denoted with the same reference symbols, and the detailed explanation thereof will be omitted.

In such a sample analysis element 11a, when the incident light of circularly-polarized light is applied, the localized surface plasmon resonance is induced on the metal film 19 of each of the nanostructures 15. The localized surface plasmon resonance is enhanced based on the segmentation in the second direction SD in addition to the segmentation in the first direction DR. The near-field light is enhanced on the metal films 19 of the nanostructures 15. So-called hot spots are formed. Moreover, since the plurality of nanostructures 15 is disposed in each of the nanostructure groups 16a, the surface density of the nanostructures 15 can be raised. Therefore, the surface density of the hot spots is increased. It should be noted that in the case in which such a sample analysis element 11a is incorporated in the target molecule detection device 31, it is sufficient for the light source 42 to emit the light of the circularly-polarized light.

It should be noted that although the present embodiment is hereinabove explained in detail, it should easily be understood by those skilled in the art that it is possible to make a variety of modifications not substantially departing from the novel matters and the advantages of the invention. Therefore, such modified examples are all included in the scope of the invention. For example, a term described at least once with a different term having a broader sense or the same meaning in the specification or the accompanying drawings can be replaced with the different term in any part of the specification or the accompanying drawings. Further, the configurations and the operations of the sample analysis element 11, 11a, the target molecule detection device 31, and so on are not limited to those explained in the present embodiment, but can variously be modified.

The entire disclosure of Japanese Patent Application No. 2012-101021 filed Apr. 26, 2012 is expressly incorporated by reference herein.

1. A sample analysis element comprising:
a base body;
nanostructures dispersed on a surface of the base body at a first pitch smaller than a wavelength of incident light; and
a plurality of nanostructure groups each including the nanostructures, wherein the nanostructure includes a dielectric body covered with a metal film, and the nanostructure groups are arranged in one direction at a second pitch larger than the first pitch.

2. The sample analysis element according to claim 1, wherein
the second pitch has a dimension based on a wavelength of a propagating surface plasmon resonance.

3. The sample analysis element according to claim 1, wherein
a region where the nanostructure does not exist is formed between the nanostructure groups.

4. The sample analysis element according to claim 1, wherein
the dielectric bodies of the nanostructures are formed integrally with the base body using a same material.

5. The sample analysis element according to claim 4, wherein
the base body is formed of a molding material.

6. The sample analysis element according to claim 1, wherein
the metal film covers a surface of the base body.

7. The sample analysis element according to claim 1, wherein
the nanostructure groups are each segmentalized into nanostructure groups arranged at the second pitch in a second direction intersecting with the one direction.

8. The sample analysis element according to claim 7, wherein
a region where the nanostructure does not exist is formed between the nanostructure groups obtained by the segmentalization.

9. A detection device comprising:
the sample analysis element according to claim 1;
a light source adapted to emit light toward the nanostructure groups; and
a light detector adapted to detect light radiated from the nanostructure groups in accordance with irradiation with the light.
